(19) United States
(12) Patent Application Publication
(10) Pub. No.: US 2009/0112506 A1
(43) Pub. Date: Apr. 30, 2009

(54) TEMPERATURE DETECTION CONTROL APPARATUS AND IMAGING APPARATUS HAVING THE SAME

(75) Inventor: Satoshi KAZAMA, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OLYMPUS CORPORATION, Tokyo (JP)

(21) Appl. No.: 12/259,618

(22) Filed: Oct. 28, 2008

(30) Foreign Application Priority Data
Oct. 30, 2007 (JP) 2007-281542

(51) Int. Cl. G06F 15/00

(52) U.S. Cl. 702/130

(57) ABSTRACT

A temperature detection control apparatus including: a temperature detection means for detecting temperature of a heat generating section; a recording means for recording detected temperatures and detection times from the temperature detection means; a prediction means for predicting an attainment prediction time till attaining a predetermined temperature based on the detected temperatures and the detection times recorded in the recording means; and a control means for, in effecting switching control of a time interval of temperature detections at the temperature detection means in accordance with a plurality of predetermined temperature ranges, setting a shorter time as the time interval of the temperature detections at the temperature detection means in the highest-temperature predetermined temperature range of the plurality of predetermined temperature ranges as compared to the other predetermined temperature ranges.

This application claims benefit of Japanese Patent Application No. 2007-281542 filed in Japan on Oct. 30, 2007, the contents of which are incorporated by this reference.

### BACKGROUND OF THE INVENTION

The present invention relates to temperature detection control apparatus and imaging apparatus having the same, and more particularly relates to the temperature detection control apparatus and the imaging apparatus having the same where a switching control can be effected of a time interval of temperature detection.

In an imaging apparatus such as digital camera, heat is generated and the temperature of the imaging apparatus rises due to an operation of internally provided electric component parts, and it is known that the rise of temperature due to heat generation becomes steeper for those operations where the power consumption of the electric component parts is greater. The heating of a solid-state imaging device, which is one of the electric component parts of the imaging apparatus, causes an increased noise and thus degrades imaging signals so that the taken image is greatly affected. Further, the rise of surface temperature of the digital camera might cause a burn on the user.

Various methods have been proposed to detect a surface temperature of digital camera so as to warn the user of the temperature rise. Japanese Patent Application Laid-Open 2007-74095 for example discloses a digital camera having the construction as follows. In particular, the digital camera disclosed in the publication detects a surface temperature of a camera body at predetermined interval by a temperature sensor so that, when a temperature is detected as having attained a hazardous temperature that is harmful to human body, the surface temperature, the hazardous temperature, a graph of the temperatures, and a warning information are displayed on an LCD, and when it is below the hazardous temperature, the time at which it will attain the hazardous temperature is predicted so as to display on the LCD the surface temperature, the hazardous temperature, a graph of the temperatures, and a prediction information.

### SUMMARY OF THE INVENTION

In a first aspect of the invention, there is provided a temperature detection control apparatus including: a temperature detection means for detecting temperature of a heat generating section; a recording means for recording detected temperatures and detection times from the temperature detection means; a prediction means for predicting an attainment prediction time till attaining a predetermined temperature based on the detected temperatures and the detection times recorded in the recording means; and a control means for, in effecting switching control of a time interval of temperature detections at the temperature detection means in accordance with a plurality of predetermined temperature ranges, setting a shorter time as the time interval of the temperature detections at the temperature detection means in the highest-temperature predetermined temperature range of the plurality of predetermined temperature ranges as compared to the other predetermined temperature ranges.

In a second aspect of the invention, the recording means in the temperature detection control apparatus according to the first aspect records the detected temperature and the detection time in cases of a first predetermined temperature or above.

In a third aspect of the invention, the prediction means in the temperature detection control apparatus according to the first aspect predicts the attainment prediction time in cases of a second predetermined temperature or above.

In a fourth aspect of the invention, in effecting switching control of the time interval of the temperature detection at the temperature detection means in the temperature detection control apparatus according to the first aspect, an attainment prediction time till attaining a higher-temperature side border temperature between the predetermined temperature ranges is predicted by the prediction means and, when the attainment prediction time is shorter than the temperature detection time interval of the subject predetermined temperature range, the control means sets the temperature detection time interval of the temperature detection means to a time interval corresponding to a predetermined temperature range bordering on the higher-temperature side.

In a fifth aspect of the invention, the temperature detection control apparatus according to the first aspect further includes a display means for displaying an attainment prediction time predicted by the prediction means when the detected temperature at the temperature detection means is at or above a third predetermined temperature and for displaying a warning when a fourth predetermined temperature has been attained.

In a sixth aspect of the invention, there is provided an imaging apparatus including: a solid-state imaging device for converting an object image into image signals; and the temperature detection control apparatus according to any one of the first to fifth aspects for detecting a temperature change of the solid-state imaging device. At least one of the means selected from the temperature detection means, the recording means, the prediction means, and the control means is formed within the same chip as the solid-state imaging device.

### BRIEF DESCRIPTION OF THE DRAWINGS

FIG. 1 is a block diagram schematically showing a main portion of digital camera according to a first embodiment of the invention.

FIG. 2 is a flowchart for explaining operation of the first embodiment shown in FIG. 1.

FIG. 3 is a graph of temperature for explaining operation of the first embodiment shown in FIG. 1.

FIG. 4 shows an example of the content of display of a display section of the first embodiment shown in FIG. 1.

FIG. 5 shows another example of the content of display of the display section of the first embodiment shown in FIG. 1.

FIG. 6 is a block diagram schematically showing construction of a main portion of a second embodiment.

FIG. 7 is a flowchart for explaining operation of the second embodiment shown in FIG. 6.

FIG. 8 is a graph of temperature for explaining operation of the second embodiment shown in FIG. 6.

### DESCRIPTION OF THE PREFERRED EMBODIMENTS

Some embodiments of the temperature detection control apparatus according to the invention and imaging apparatus having the same will be described below with reference to the drawings.

### Embodiment 1

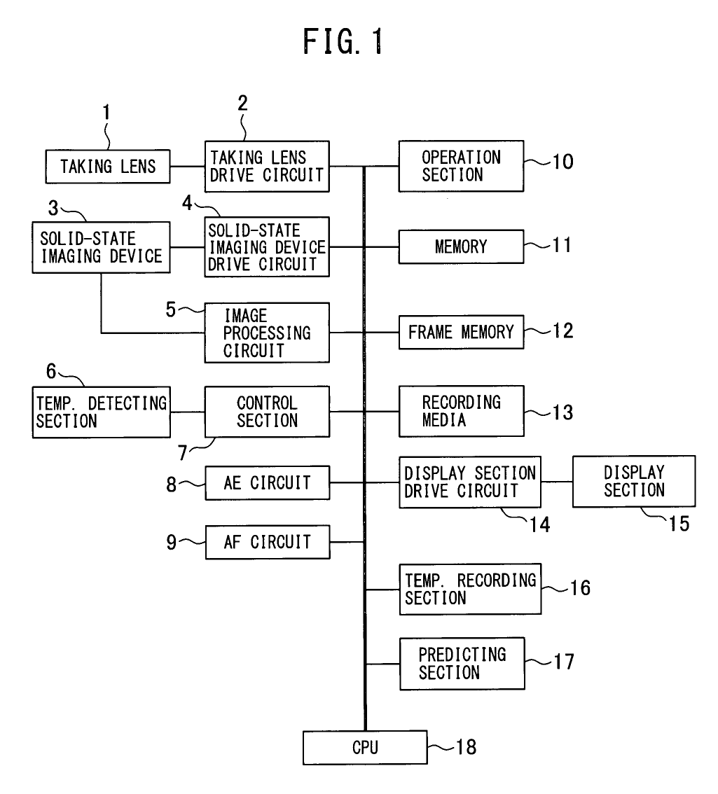

A first embodiment according to the invention will now be described. The present embodiment is an embodiment corresponding to the first, second, third and fifth aspects of the invention, and will be described as one where the invention is applied by way of an example to a digital camera. FIG. 1 is a block diagram schematically showing an example of construction of a main portion of digital camera according to the first embodiment. The digital camera according to the first embodiment includes: a taking lens 1; a taking lens drive circuit 2; a solid-state imaging device 3; a solid-state imaging device drive circuit 4; an image processing circuit 5; a temperature detecting section 6; a control section 7; an AE circuit 9; an AF circuit 9; an operation section 10; a memory 11; a frame memory 12; a recording media 13; a display section drive circuit 14; a display section 15; a temperature recording section 16; a predicting section 17; a CPU 18; and a power supply (not shown). These are suitably disposed within a camera body (not shown). It should be noted that the above described temperature detecting section 6, control section 7, display section 15, temperature recording section 16, and predicting section 17 respectively correspond to the temperature detection means, control means, display means, recording means, and prediction means which are used as the terms in claims.

The taking lens 1 is formed of a zoom lens system and its drive motor, a focus lens system and its drive motor, an optical aperture stop and its drive motor, a mechanical shutter and its drive motor, etc. so as to form an object image on the solid-state imaging device 3. The taking lens drive circuit 2 is formed of driver circuits for driving each drive motor of the taking lens 1, etc. so as to control a timing of the taking lens 1. The solid-state imaging device 3 has a light receiving section where several million pixels are two-dimensionally arranged, and converts light signals of the object image formed through the taking lens 1 into electrical signals. One having function for converting light signals into electrical signals such as CCD or CMOS image sensor suffices as the solid-state imaging device 3.

The solid-state imaging device circuit 4 is formed of a TG (timing generator) circuit for generating a clock pulse to drive the solid-state imaging device 3, a power supply circuit, etc. so as to control a timing of the solid-state imaging device 3. The image processing circuit 5, which effects various signal processing, includes a CDS (correlation double sampling) processing circuit for removing noise components mixed into an output signal of the solid-state imaging device 3, an AGC (automatic gain control) processing circuit for amplifying the output signal, a processing circuit for generating image data by effecting ADC (analog-to-digital signal conversion) processing of the output signal, and a processing circuit for effecting γ-correction, white balance adjustment, color conversion, and image compression on the image data. Further, the image processing circuit 5 has a function for storing the image data into the frame memory 12, and function for recording compressed image data into the recording media 13.

The temperature detecting section 6 is formed of a temperature sensor, and the temperature sensor is disposed in the vicinity of the solid-state imaging device 3 to detect a temperature of the solid-state imaging device 3. Such as a resistor, thermistor, thermocouple, or semiconductor may be used as the temperature sensor. Further, there is an advantage of facilitating a reduction of error in the temperatures by forming the temperature detecting section 6 on the same chip as the solid-state imaging device 3. Furthermore, the temperature detecting section 6 may also be disposed in the vicinity of or be formed on the same chip as those electrical components which consume a great amount of power, such as the image processing circuit 5 or the CPU 18 other than the solid-state imaging device 3.

The control section 7 is formed of a TG (timing generator) circuit, etc., and is to control a timing of time interval of temperature detection by the temperature detecting section 6. It controls the switching of the temperature detection time interval in accordance with a plurality of predetermined temperature ranges of the solid-state imaging device 3. Further, the control section 7 may be disposed in the vicinity of or be formed on the same chip as such electrical components as the solid-state imaging device 3, image processing circuit 5, or CPU 18 in a similar manner as the temperature detecting section 6. The AE circuit 8 effects an automatic exposure computation processing based on the image data from the image processing circuit 5. The AF circuit 9 effects an autofocus computation processing based on the image data from the image processing circuit 5. The operation section 10 is formed of a switch for ON/OFF of the power supply of the digital camera, a switch for switching between a plurality of operation modes of the digital camera, a release button, etc., and the operation section 10 makes it possible for the user to operate the digital camera.

The operation modes of the digital camera here may include: a moving picture taking mode; a consecutive taking mode; a still picture taking mode; an electronic live view mode where image data from the solid-state imaging device 3 are consecutively displayed on the display section 15; a reproduction mode where images recorded in the recording media 13 are reproduced/displayed on the display section 15; and a standby mode. Various operation programs, adjusting data and the like of the digital camera are saved in the memory 11. The memory 11 also saves for example data of the temperature detection time intervals, the plurality of predetermined temperature ranges, and a plurality of predetermined temperatures of the digital camera according to the present embodiment.

The frame memory 12 is a memory for temporarily storing the image data or the like of the image processing circuit 5. The recording media 13 is a recording medium for recording compression image data and is formed for example of a memory card which is attachable/detachable to/from the digital camera. The display section drive circuit 14 includes a driver circuit or the like for driving the display section 15 so as to control the displaying on the display section 15. The display section 15 is formed of an LCD on which the image data in the image processing circuit 5 and the compression image data recorded in the recording media 13 for example are displayed. The display section 15 also displays temperature data recorded in the temperature recording section 16, a hazardous temperature attainment prediction time predicted at the predicting section 17, and a warning for notifying an attainment of the hazardous temperature, etc.

The temperature recording section 16 is formed of a memory for recording temperature data when the detected temperature at the temperature detecting section 6 is at or above a predetermined temperature. The predicting section 17 is formed of an operation circuit for predicting a time till attaining a predetermined temperature based on temperature data in the temperature recording section 16. The CPU 18 reads in various operation programs and various data of the digital camera stored in the memory 11, and effects general control of the operation of the digital camera as a whole. The CPU 18 also compares the detected temperature at the temperature detecting section 6 with the predetermined temperature to make decision so as to control the control section 7, temperature recording section 16, the predicting section 17, and the display section drive circuit 14. The solid-state imaging device drive circuit 4, CDS and AGC and ADC among the circuits constituting the image processing circuit 5, the temperature recording section 16, and the predicting section 17 may be formed on the same chip as the solid-state imaging device 3. These are readily formed on the same chip in a manufacturing process especially in the case of a CMOS image sensor.

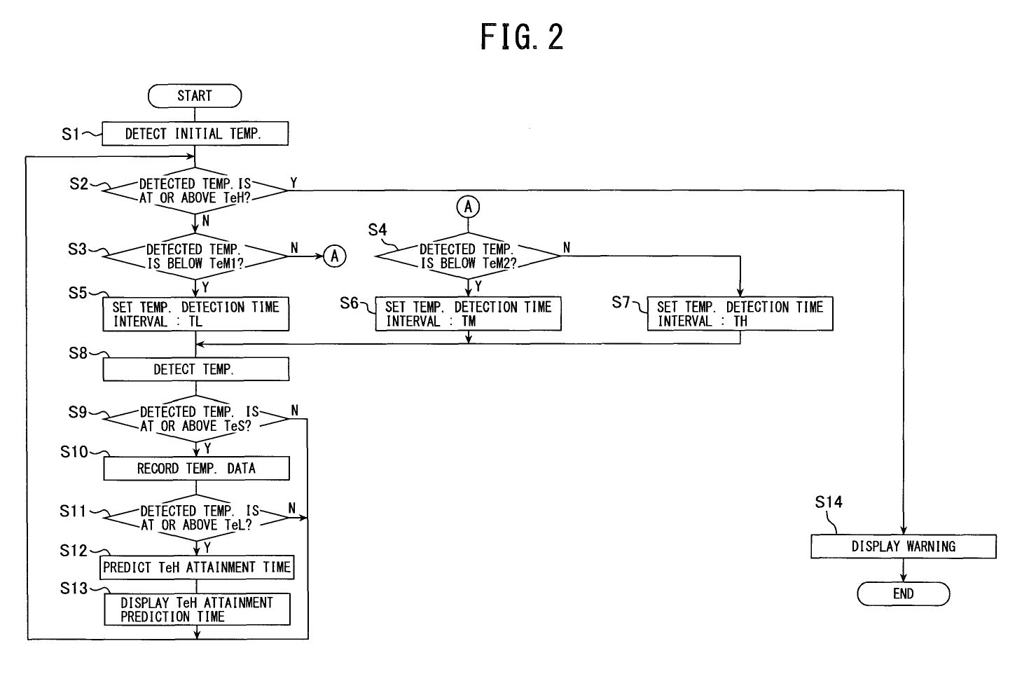

An operation of the present embodiment will now be described by way of a flowchart shown in FIG. 2. FIG. 2 shows the case where three temperature ranges are provided for the solid-state imaging device 3 as the plurality of predetermined temperature ranges in the invention. In particular, the three are a temperature range L that is below TeM1, a temperature range M that is above TeM1 and below TeM2, and a temperature range H that is above TeM2 and below TeH. All temperatures are indicated in the scale of (° C.). There is a relationship of TeM1<TeM2<TeH among the degrees of the temperatures TeM1, TeM2, and TeH, and that for the three temperature ranges is temperature range L<temperature range M<temperature range H. It should be noted that TeH is a temperature corresponding to the hazardous temperature or a fourth predetermined temperature in the invention.

Further, the temperature detection time intervals of the temperature detecting section 6 in each temperature range in the present embodiment are TL(s)=4×TH(s) for temperature range L, TM(s)=2×TH(s) for temperature range M, and TH(s) for temperature range H, and there is a relationship of TL(s)>TM(s)>TH(s) in the time length of the three temperature detection time intervals. TeS in FIG. 2 is a temperature corresponding to a first predetermined temperature in the invention, where a detected temperature and detection time (hereinafter referred to as temperature data) are recorded at the temperature recording section 16 when the detected temperature at the temperature detecting section 6 is at or above TeS. Further, TeL is a temperature corresponding to a second and a third predetermined temperatures of the invention, where the hazardous temperature attainment prediction time is predicted at the predicting section 17 and the hazardous temperature attainment prediction time is displayed on the display section 15 when a detected temperature at the temperature detecting section 6 is at or above TeL. There is a relationship of TeS<TeL between the degrees of the temperatures TeS and TeL.

While TL(s)=4×TH(s) and TM(s)=2×TH(s) are set in the present embodiment, it is not limited to this provided that the relationships of TL(s)>TH(s) and TM(s)>TH(s) hold. Further, while TeS and TeL are separately set, it is naturally also possible to set these in common. Furthermore, while TeL is set in common as the second and third predetermined temperatures, the second and third predetermined temperatures may naturally be set at separate temperatures. In other words, the relationship of [first predetermined temperature≦second predetermined temperature≦third predetermined temperature≦fourth predetermined temperature] suffices.

An operation mode shown in FIG. 2 will now be described in detail. An initial temperature of the solid-state imaging device 3 is detected at the temperature detecting section 6 immediately after the turning ON of the power supply of the digital camera by the operation section 10 (step S1). Next, a comparison is made to determine whether the detected temperature is at or above the hazardous temperature, or not (step S2). If the detected temperature is at or above TeH, a warning is displayed on the display section 15 (step S14). If the detected temperature is below TeH, a further comparison is made to determine whether the detected temperature is below TeM1 or not (step S3). If the detected temperature is below TeM1, the temperature detection time interval at the temperature detecting section 6 is set to TL(s) (step S5).

If, on the other hand, the detected temperature is at or above TeM1, a further comparison is made to determine whether the detected temperature is below TeM2 or not (step S4). If the detected temperature is below TeM2, the temperature detection time interval at the temperature detecting section 6 is set to TM(s) (step S6). If, on the other hand, the detected temperature is at or above TeM2, the temperature detection time interval at the temperature detecting section 6 is set to TH(s) (step S7).

A temperature detection of the solid-state imaging device 3 is then effected at the temperature detection time interval of the temperature detecting section 6 which is set at TL(s) or TM(s) or TH(s) (step S8). Next, it is determined whether the detected temperature is at or above TeS, or not (step S9). If the detected temperature is at or above TeS, the temperature data are recorded at the temperature recording section 16 (step S10). If, on the other hand, the detected temperature is below TeS, the system returns to step S2. Next, a comparison is made to determine whether the detected temperature is at or above TeL, or not (step S11). If the detected temperature is below TeL, the operation step returns to step S2. If, on the other hand, the detected temperature is at or above TeL, a prediction time till attaining hazardous temperature TeH is predicted based on the temperature data in the temperature recording section 16 (step S12), and the hazardous temperature TeH attainment prediction time is displayed on the display section 15 (step S13), and the operation step returns to step S2. The above described operation flow but step S1 is repeated until a turning OFF of the power supply of the digital camera.

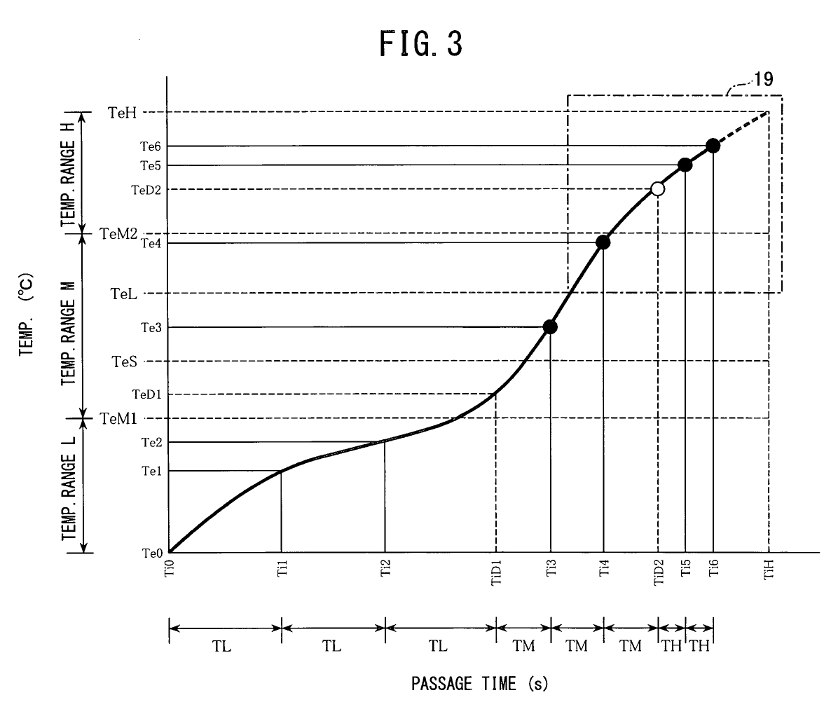

An operation of the present embodiment will now be described by way of a temperature graph shown in FIG. 3. FIG. 3 shows an operation of the case where temperature detection at the temperature detecting section 6 is effected three times each for the temperature ranges in accordance with the flowchart shown in FIG. 2. Referring to FIG. 3, X-axis represents a time passage (s) after the turning ON of the power supply of the digital camera, and Y-axis represents a temperature (° C.). Further, the thick line represents an example of temperature characteristic of the solid-state imaging device 3, and the dashed thick line represents a predicted characteristic till attaining the hazardous temperature TeH. While it is shown as the case where the first predetermined temperature TeS and the second and third predetermined temperatures TeL are set between the lower limit temperature TeM1 of the temperature range M and the lower limit temperature TeM2 of the temperature range H, the setting is not limited to this provided that the relationship of TeS≦TeL holds.

The detected temperatures by the temperature detecting section 6 are Te0, Te1, Te2 in the temperature range L, TeD1, Te3, Te4 in the temperature range M, and TeD2, Te5, Te6 in the temperature range H. Of these, the five measurements of Te3, Te4, TeD2, Te5, and Te6 indicated by black dots () and white dot (◯) are recorded at the temperature recording section 16. The white dot (◯) indicates the temperature TeD2 to be described later. A dashed line portion 19 indicates the extent of a graph to be displayed on the display section 15.

A detailed description will be given below with respect to the temperature graph of FIG. 3. At time Ti0(s) immediately after the turning ON of the power supply of the digital camera by the operation section 10, the initial temperature Te0 of the solid-state imaging device 3 is detected. Subsequently, Te1 at time Ti1(s), Te2 at time Ti2(s), and TeD1 at time TiD1(s) are respectively detected at intervals TL(s). Here, though TeD1 is a temperature in the temperature range M exceeding the lower limit temperature TeM1 of the temperature range M, it is detected at the interval TL(s) because the temperature detection time interval TL(s) has not been switched to the temperature detection time interval TM(s) of the temperature range M. Subsequently, Te3 at time Ti3(s), Te4 at time T14(s), TeD2 at time TiD2(s) are detected at the temperature detection time interval TM(s) of the temperature range M. Here, since Te3, Te4, and TeD2 are at or above the first predetermined temperature TeS, their temperature data are recorded at the temperature recording section 16.

Here, though TeD2 is a temperature in the temperature range H exceeding the lower limit temperature TeM2 of the temperature range H, it is detected at interval TM(s) because the temperature detection time interval TM(s) has not been switched to the temperature detection time interval TH(s) of the temperature range H. Subsequently, Te5 at time T15(s) and Te6 at time T16(s) are detected at the temperature detection time interval TH(s) of the temperature range H. Here, since Te5 and Te6 are at or above the first predetermined temperature TeS, their temperature data are recorded at the temperature recording section 16. At the predicting section 17, a hazardous temperature TeH attainment prediction time of (TiH−Ti6)(s) is predicted. Here, it is supposed but is not limited to this that the temperature data for four different time passages or Ti4(s) and Te4, TiD2(s) and TeD2, Ti5(s) and Te5, and Ti6(s) and Te6 are required for the prediction of time (TiH−Ti6)(s) and that a prediction time is obtained based on these. The time required to predict (TiH−Ti6) (s) is TH×4(s)(=Ti6−ti4(s)=TM+TH+TH(s)).

In the present embodiment, the temperature detection time interval set for each predetermined temperature range is effective also for the first measurement that is made in a higher-temperature side of the temperature range adjacent to the temperature range beyond its border temperature. In particular, TeD1 in the temperature range M is detected one time at the temperature detection time interval TL(s) of the temperature range L, and TeD2 in the temperature range H is detected one time at the temperature detection time interval TM(s) of the temperature range M.

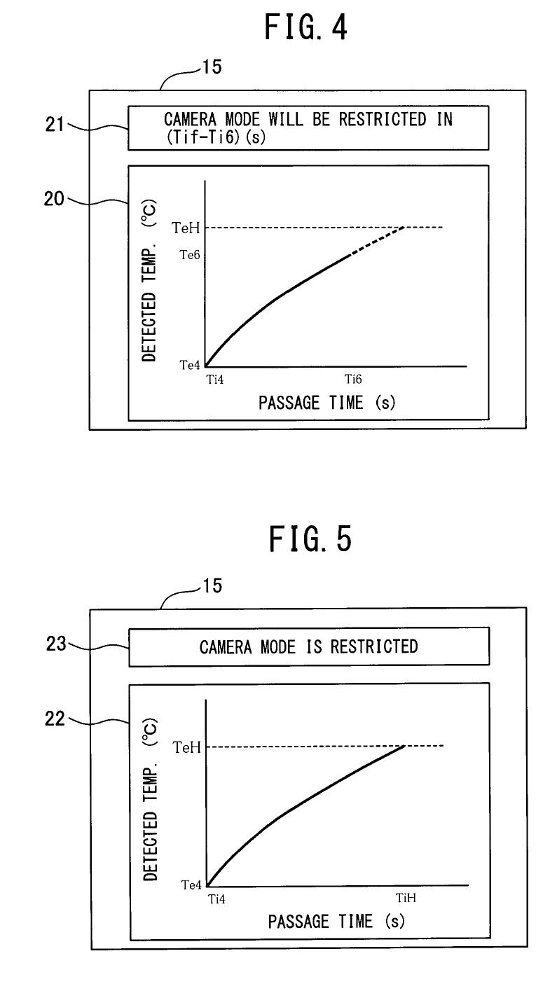

The display content on the display section 15 shown in FIGS. 4 and 5 will now be described. FIG. 4 displays a graph 20 as indicated by the dashed line portion 19 of FIG. 3 and notification information 21 to the user. FIG. 5 displays a graph 22 of the case where the hazardous temperature TeH has been attained in the dashed line portion 19 of FIG. 3 and warning information 23 to the user. Here, FIG. 4 may be displayed on the display section 15 every time when temperature is detected, and it is also possible to display only one of the graph 20 or the notification information 21. Further, in the case where photograph image and reproduced image are displayed on the display section 15, it may be simultaneously displayed in a reduced size.

It is also possible of FIG. 5 to display only one of the graph 22 or warning information 23, and in the case where photograph image and reproduced image are displayed on the display section 15, it may be simultaneously displayed in a reduced size. The display content of the display section 15 is shown here by way of an example only and is not limited to this. An ON/OFF of the displaying of FIGS. 4 and 5 may be controlled through the operation section 10. Further, it is also possible to use other and different displaying methods. For example, an LED emission or generated sound or the like may be used instead of the display section 15, and it is also possible to use these in combination with each other. In a word, whatever is capable of notifying or warning the user of the digital camera may be used.

According to the present embodiment as has been described, a switching control is effected at the control section 7 in accordance with the three predetermined temperature ranges (temperature range L, temperature range M, and temperature range H) of the solid-state imaging device 3 so that the temperature detection time interval (TL, TM, TH) at the temperature detecting section 3 is shorter for the higher temperature ranges (TL>TM>TH). It is thereby possible to secure an accuracy of detection of the hazardous temperature (TeH) and an accuracy of prediction of the hazardous temperature attainment prediction time (TiH−Ti6) at the predicting section 17, and at the same time to reduce the recording capacity of temperature data at the recording section 16. All of the securing of detection accuracy of the hazardous temperature, the securing of prediction accuracy of the hazardous temperature attainment prediction time, and the reduction of the recording capacity, therefore, can be simultaneously satisfied.

Further, since temperature data are recorded at the temperature recording section 16 only when the detected temperature is at or above a predetermined temperature (TeS), the advantage of reducing the capacity of the recording section 16 is facilitated. While the case where the number of the plurality of predetermined temperature ranges is three has been shown, it is not limited to this. While the recording of temperature data at the temperature recording section 16 has been effected when it is at or above a predetermined temperature (TeS), the number of data to be recorded can be reduced even when the recording is started immediately after the turning ON of the power supply of the digital camera, since the temperature detection time interval is longer when the digital camera is at low temperatures. It is thereby naturally possible to simultaneously satisfy all of the securing of accuracy of the hazardous temperature detection and the hazardous temperature attainment prediction time, and a reduction of the recording capacity.

For the user of a digital camera, notification information of the hazardous temperature attainment prediction time when the detected temperature is low is unnecessary but it is bothersome. For this reason, the hazardous temperature attainment prediction time is predicted by the predicting section 17 and at the same time the hazardous temperature attainment prediction time is displayed on the display section 15 only when the detected temperature is at or above a predetermined temperature (TeL) which is closer to the hazardous temperature. It is thereby made convenient to use. Further, since the temperature recording section 16, predicting section 17, and display section 15 are caused to operate only for the cases of the predetermined temperature or above, there is also an advantage of reducing power consumption.

### Embodiment 2

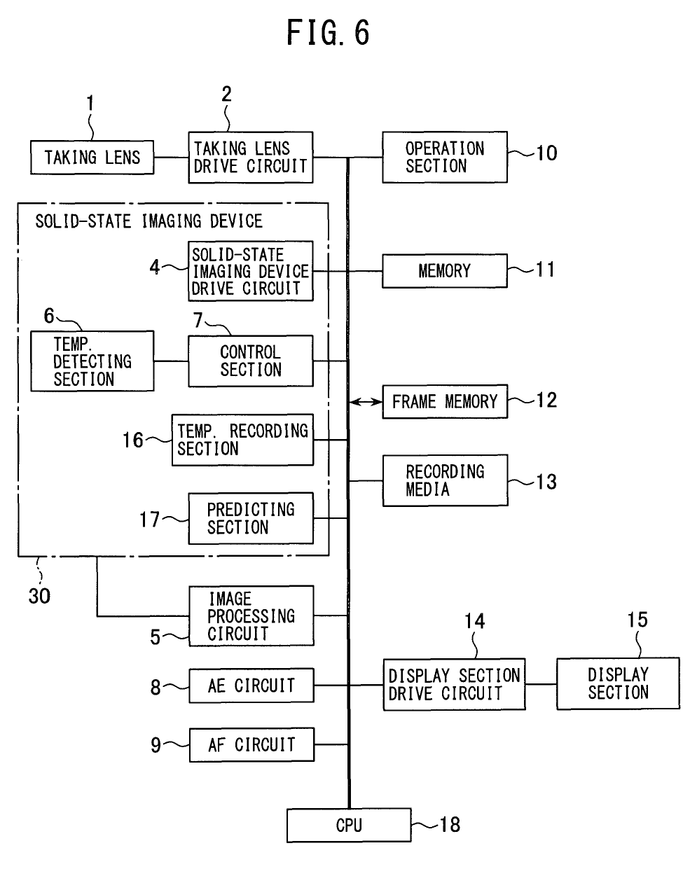

A second embodiment of the invention will now be described by way of FIGS. 6 to 8. The present embodiment is an embodiment corresponding to the first, second, third, fourth, fifth, and sixth aspects of the invention, and is different from the first embodiment shown in FIG. 1 in two points, i.e. a main fundamental construction of the digital camera, and the control method of switching of the temperature detection time interval of the temperature detecting section 6 at border temperatures between the predetermined temperature ranges. FIG. 6 is a block diagram showing an example of fundamental construction of a main portion of digital camera that is different from the first embodiment shown in FIG. 1, where like components as in the first embodiment shown in FIG. 1 are denoted by like reference numerals. The only portion different from the first embodiment shown in FIG. 1 is the construction of the solid-state imaging device 30. In the present embodiment, the solid-state imaging device drive circuit 4, temperature detecting section 6, control section 7, temperature recording section 16, predicting section 17 are formed on the same chip as the solid-state imaging device 30. The construction of the rest is similar to the first embodiment shown in FIG. 1 and will not be described.

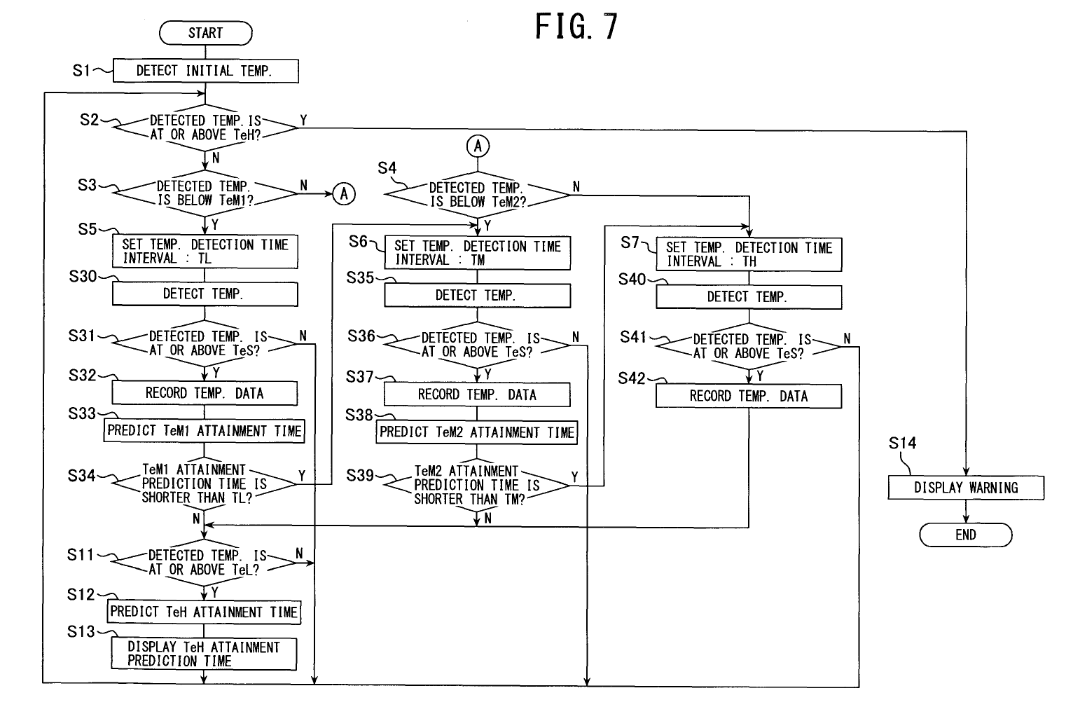

An operation of the present embodiment will now be described by way of a flowchart shown in FIG. 7. FIG. 7 shows a case similar to FIG. 1 where three temperature ranges are provided of the solid-state imaging device 3 as the plurality of predetermined temperature ranges in the invention. In particular, the three are a temperature range L that is below TeM1, a temperature range M that is at or above TeM1 and below TeM2, and a temperature range H that is at or above TeM2 and below TeH. There are relationships in the degrees of the temperatures of TeM1<TeM2<TeH and temperature range L<temperature range M<temperature range H. Though a description will be given below with determining a lower limit temperature TeM1 of the temperature range M as the border temperature between the temperature range L and the temperature range M and a lower limit temperature TeM2 of the temperature range H as the border temperature between temperature range M and temperature range H, it is also possible to determine upper limit values of each temperature range, i.e. the temperature range L and the temperature range M as border temperatures. It should be noted that TeH is a temperature corresponding to the hazardous temperature or a fourth predetermined temperature in the invention. Further, the temperature detection time intervals of the temperature detecting section 6 in each temperature range of the second embodiment are determined similarly to the first embodiment as TL(s)=4×TH(s) for temperature range L, TM(s)=2×TH(s) for temperature range M, and TH(s) for temperature range H so that there is a relationship of TL(s)>TM(s)>TH(s).

TeS in FIG. 7 is a temperature corresponding to the first predetermined temperature in the invention, and temperature data are recorded at the temperature recording section 16 when the detected temperature at the temperature detecting section 6 is at or above TeS. Further, TeL is a temperature corresponding to a second and a third predetermined temperatures of the invention, where a hazardous temperature attainment prediction time is predicted at the predicting section 17 and the hazardous temperature attainment prediction time is displayed on the display section 15 when the detected temperature at the temperature detecting section 6 is at or above TeL. There is a relationship of TeS<TeL between the degrees of the temperatures TeS and TeL. While TL(s)=4×TH(s) and TM(s)=2×TH(s) are set in the present embodiment, it is not limited to this provided that the relationships of TL(s)>TH(s) and TM(s)>TH(s) are satisfied. Further, while TeS and TeL are separately set, it is naturally also possible to set these in common. Furthermore, while TeL is set in common as the second and third predetermined temperatures, the second and third predetermined temperatures may naturally be set at separate temperatures.

In other words, the relationship of [first predetermined temperature≦second predetermined temperature≦third predetermined temperature<fourth predetermined temperature] suffices.

An operation mode shown in FIG. 7 will be described below in detail. FIG. 7 where those steps identical to FIG. 2 are denoted by identical reference numerals is different from the flowchart shown of the first embodiment in FIG. 2 in the control method of switching of the temperature detection time interval of the temperature detecting section 6 at border temperatures between the predetermined temperature ranges. At first, an initial temperature of the solid-state imaging device 30 is detected at the temperature detecting section 6 immediately after the turning ON of the power supply of the digital camera by the operation section 10 (step S1). Next, a comparison is made to determine whether the detected temperature is at or above the hazardous temperature, or not (step S2). If the detected temperature is at or above TeH, the warning is displayed on the display section 15 (step S14). If, on the other hand, the detected temperature is below TeH, a further comparison is made to determine whether the detected temperature is below the border temperature TeM1 or not (step S3). If the detected temperature is below TeM1, the temperature detection time interval at the temperature detecting section 6 is set to TL(s) (step S5). If, on the other hand, the detected temperature is at or above TeM1, the operation step proceeds to step S4.

Next, a temperature detection of the solid-state imaging device 30 is effected by the temperature detecting section 6 at the temperature detection time interval which has been set to TL(s) (step S30). Subsequently, a comparison is made to determine whether the detected temperature is at or above TeS, or not (step S31). If the detected temperature is below TeS, the operation step returns to step S2. If, on the other hand, the detected temperature is at or above TeS, temperature data are recorded at the temperature recording section 16 (step S32).

Next, time till attaining the border temperature TeM1 between the temperature range L and the temperature range M is predicted based on the temperature data in the temperature recording section 16 (step S33). A comparison is then made to determine whether the attainment prediction time up to the border temperature TeM1 is shorter than TL(s) or not (step S34). If the attainment prediction time is shorter than TL(s), the operation step proceeds to step S6. If, on the other hand, the attainment prediction time is longer than TL(s), a comparison is made to determine whether the detected temperature is at or above TeL, or not (step S11). If the detected temperature is below TeL, the operation step returns to step S2. If, on the other hand, the detected temperature is at or above TeL, the hazardous temperature TeH attainment prediction time is predicted based on the temperature data in the temperature recording section 16 (step S12) and the hazardous temperature TeH attainment prediction time is displayed on the display section 15 (step S13), and the operation step returns to step S2.

If the detected temperature is at or above TeM1 at the foregoing step S3, a comparison is subsequently made to determine whether the detected temperature is below TeM2 or not (step S4). If the detected temperature is at or above TeM2, the operation step proceeds to step S7. If, on the other hand, the detected temperature is below TeM2, the temperature detection time interval of the temperature detecting section 6 is set to TM(s) (step S6). A temperature of the solid-state imaging device 30 is then detected at the temperature detection time interval of the temperature detecting section 6 which has been set to TM(s) (step S35). Next, a comparison is made to determine whether the detected temperature is at or above TeS, or not (step S36). If the detected temperature is below TeS, the operation step returns to step S2. If, on the other hand, the detected temperature is at or above TeS, temperature data are recorded at the temperature recording section 16 (step S37).

Next, time till attaining the border temperature TeM2 between the temperature range M and the temperature range L is predicted based on the temperature data in the temperature recording section 16 (step S38). A comparison is subsequently made to determine whether the attainment prediction time up to the border temperature TeM2 is shorter than TM(s) or not (step S39). If the attainment prediction time is shorter than TM(s), the operation step proceeds to step S7. If, on the other hand, the attainment prediction time is longer than TM(s), the operation step proceeds to step S11. If the detected temperature is at or above TeM2 at the above described step S4, the temperature detection time interval of the temperature detecting section 6 is set to TH(s) (step S7). A temperature detection of the solid-state imaging device 30 is then effected at the temperature detection time interval of the temperature detecting section 6 which has been set to TH(s)(step S40). Next, a comparison is made to determine whether the detected temperature is at or above TeS, or not (step S41). If the detected temperature is below TeS, the operation step returns to step S2. If, on the other hand, the detected temperature is at or above TeS, temperature data are recorded at the temperature recording section 16 (step S42) and the operation step proceeds to step Sit. The above described flow but step S1 is repeated until a turning OFF of the power supply of the digital camera.

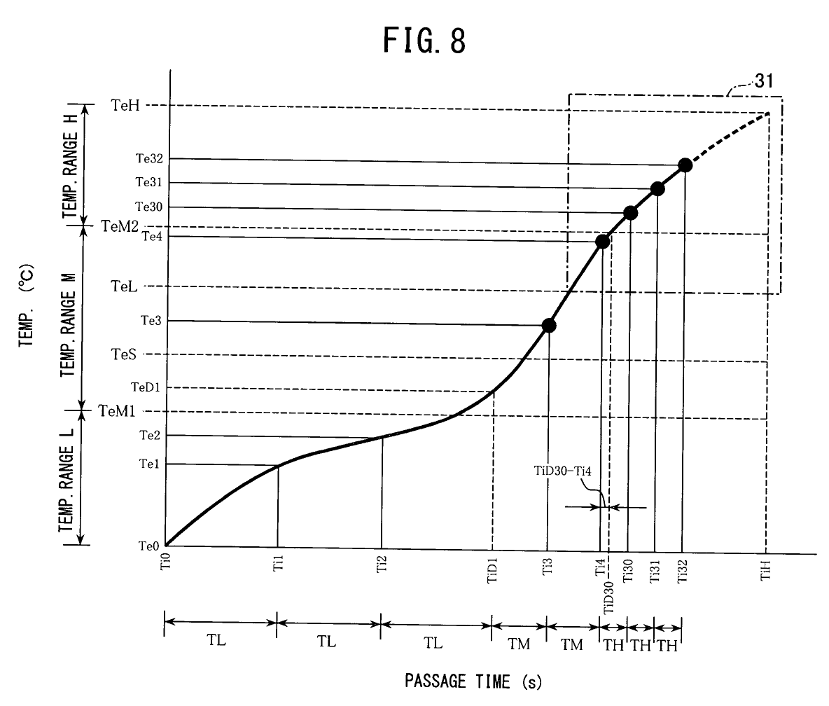

An operation of the present embodiment will now be described by way of a temperature graph shown in FIG. 8. FIG. 8 shows the case where temperature detection at the temperature detecting section 6 is effected three times each for the temperature ranges in accordance with the flowchart shown in FIG. 7. In FIG. 8, like portions as in the temperature graph of FIG. 3 are denoted by like reference symbols, though it is different from the temperature graph of the first embodiment shown in FIG. 3 in the control method of switching of the temperature detection time interval at TeM2 which is the border temperature between the temperature range M and the temperature range H, and in temperature data to be detected in the temperature range H. Referring to FIG. 8, the thick line represents an example of temperature characteristic of the solid-state imaging device 30, and the dashed thick line represents a predicted characteristic till attaining the hazardous temperature TeH.

The detected temperatures by the temperature detecting section 6 are Te0, Te1, Te2 in the temperature range L, TeD1, Te3, Te4 in the temperature range M, and Te30, Te31, Te32 in the temperature range H. Of these, the five measurements of Te3, Te4, Te30, Te31, and Te32 indicated by black dots () are recorded at the temperature recording section 16. As compared to the temperature graph of FIG. 3, therefore, the temperature of TeD2 [white dot (◯)] is not detected, which was in the foregoing case detected with using the temperature detection time interval TM(s) of the temperature range M one time only in the temperature range H bordering on the higher-temperature side. A dashed line portion 31 shown in FIG. 8 indicates the extent of a graph to be displayed on the display section 15.

A detailed description will be given below with respect to the temperature graph of FIG. 8. At first, at time Ti0(s) immediately after the turning ON of the power supply of the digital camera by the operation section 10, an initial temperature Te0 of the solid-state imaging device 30 is detected. Subsequently, Te1 at time Ti1(s), Te2 at time T12(s), and TeD1 at time TiD1(s) are respectively detected at intervals TL(s). Here, though TeD1 is a temperature in the temperature range M exceeding the border temperature TeM1, it is detected at the temperature detection time interval TL(s). The reason for this is that the temperature detection time interval TL(s) has not been switched to TM(s), since time till attaining the border temperature TeMt is not predicted because the detected temperature Te2 is below the first predetermined temperature TeS. Subsequently, Te3 at time T13(s), Te4 at time T14(s) are detected at the time interval of TM(s). Here, since the detected temperatures Te3 and Te4 are at or above the first predetermined temperature TeS, their temperature data are recorded at the temperature recording section 16.

Further, since time till attaining the border temperature TeM2 between the temperature range M and the temperature range H from the detected temperature Te4, i.e. (TiD30-Ti4)(s) is shorter as compared to the temperature detection time interval TM(s) of the temperature range M, the temperature detection time interval is switched/controlled from TM(s) to the temperature detection time interval TH(s) of the temperature range H. Here, it is supposed but is not limited to this that the prediction of time (TiD30-Ti4)(s) is obtained based on the two temperature data, i.e. detected temperature Te3 at Ti3(s) and detected temperature Te4 at Ti4(s).

Subsequently, Te30 at time T130(s), Te31 at time Ti31(s), Te32 at time Ti32(s) are respectively detected at the interval of TH(s). Here, since the detected temperatures Te30, Te31, and Te32 are at or above the first predetermined temperature TeS, their temperature data are recorded at the temperature recording section 16. Next, a hazardous temperature TeH attainment prediction time of (TiH−Ti32)(s) is predicted at the predicting section 17. It is supposed here for a comparison with the temperature graph shown in FIG. 3 that the prediction of the hazardous temperature attainment prediction time (TiH−Ti32)(s) requires four temperature data, and that it is obtained based on these. In particular, these are temperature data for four different time passages, i.e. Ti4(s) and Te4, Ti30(s) and Te30, Ti31(s) and Te31, Ti32(s) and Te32. The time required to predict the above hazardous temperature attainment prediction time (TiH−Ti32)(s) is THX 3(s) (=Ti32−Ti4(s)=TH+TH+TH(s)). As compared to the first embodiment shown in FIG. 3, therefore, a hazardous temperature attainment prediction time can be predicted in time which is shorter by TH(s). This difference TH(s) in the hazardous temperature attainment prediction time occurs due to the difference from the switching control method in the first embodiment regarding the temperature detection time interval with respect to TeM2 which is the border temperature between the temperature range M and the temperature range H.

Though the display content at the display section 15 and notification/warning to the user of the digital camera will not be described in detail, various modifications and alterations thereof are possible as has been described in the first embodiment without departing from the purpose thereof.

As has been described, it is naturally possible according to the present embodiment to obtain the advantages as described in the first embodiment. Further, in the first embodiment, the temperature detection time interval set for each predetermined time interval becomes effective for a first one time only also in a temperature range bordering on the higher-temperature side beyond the border temperature of the temperature range, resulting in a detection of temperature at such time interval. In the second embodiment, on the other hand, since detection of temperature at such time interval is not effected, the time required to predict a hazardous temperature attainment prediction time at the prediction means can be made shorter as compared to the first embodiment. Further, by forming the temperature detection means, the recording means, the prediction means, and the control means within the same chip as the solid-state imaging device, it is possible to facilitate a reduction of error in temperature in detecting the temperatures, and to reduce the number of component parts of the imaging apparatus so as to reduce costs at the same time of reducing the size and weight of the imaging apparatus. It should be noted that embodiments according to the invention are not limited to digital cameras, and it can naturally be applied not only to those apparatus/equipment having an imaging function but also to those apparatus/equipment without an imaging function.

According to the first aspect of the invention as has been described by way of the above embodiments, the time interval of temperature detection at the temperature detection means is set to be shorter in a higher-temperature predetermined temperature range in the vicinity of a hazardous temperature so that a detection accuracy of the hazardous temperature at the temperature detection means can be secured and at the same time a prediction accuracy of the hazardous temperature attainment prediction time by the prediction means can be secured. According to the second aspect, the number of detected temperatures and detection time (temperature data) to be recorded at the recording means can be reduced. According to the third aspect, it is possible that a hazardous temperature attainment prediction time be predicted at the prediction means only in the vicinity of the hazardous temperature. According to the fourth aspect, time required to predict a hazardous temperature attainment prediction time at the prediction means can be made shorter. According to the fifth aspect, it becomes possible to display a hazardous temperature attainment prediction time at the display means only in the vicinity of the hazardous temperature, and also to display a warning to the user that the hazardous temperature has been attained. According to the sixth aspect, the number of component parts of the imaging apparatus can be reduced so that a reduction in size and weight of the imaging apparatus becomes possible at the same time of reducing costs, and in addition, it becomes possible to facilitate a reduction of error in the detected temperatures.

What is claimed is:

1. A temperature detection control apparatus comprising:
a temperature detection means for detecting temperature of a heat generating section;
a recording means for recording detected temperatures and detection times from said temperature detection means;
a prediction means for predicting an attainment prediction time till attaining a predetermined temperature based on the detected temperatures and the detection times recorded in said recording means; and a control means for, in effecting switching control of a time interval of temperature detections at said temperature detection means in accordance with a plurality of predetermined temperature ranges, setting a shorter time as the time interval of the temperature detections at said temperature detection means in the highest-temperature predetermined temperature range of said plurality of predetermined temperature ranges as compared to the other predetermined temperature ranges.

2. The temperature detection control apparatus according to claim 1, wherein said recording means records the detected temperature and the detection time in cases of a first predetermined temperature or above.

3. The temperature detection control apparatus according to claim 1, wherein said prediction means predicts said attainment prediction time in cases of a second predetermined temperature or above.

4. The temperature detection control apparatus according to claim 1, wherein, in effecting switching control of the time interval of the temperature detection at said temperature detection means, an attainment prediction time till attaining a higher-temperature side border temperature between said predetermined temperature ranges is predicted by said prediction means and, when the attainment prediction time is shorter than the temperature detection time interval of the subject predetermined temperature range, said control means sets the temperature detection time interval of said temperature detection means to a time interval corresponding to a predetermined temperature range bordering on the higher-temperature side.

5. The temperature detection control apparatus according to claim 1 further comprising a display means for displaying an attainment prediction time predicted by said prediction means when the detected temperature at said temperature detection means is at or above a third predetermined temperature and for displaying a warning when a fourth predetermined temperature has been attained.

6. An imaging apparatus comprising: a solid-state imaging device for converting an object image into image signals; and
the temperature detection control apparatus according to any one of claims 1 to 5 for detecting a temperature change of said solid-state imaging device;
wherein at least one means selected from said temperature detection means, said recording means, said prediction means, and said control means is formed within the same chip as said solid-state imaging device.
